(19) United States
(12) Patent Application Publication
(10) Pub. No.: US 2004/0030018 A1
(43) Pub. Date: Feb. 12, 2004

(54) Polyformaldehyde like high polymeric compound plastic particle

(76) Inventor: Jin-Long Wu, Taichung (TW)

Correspondence Address: Jin-Long Wu, 58, MA YUAN WEST ST., TAICHUNG, TW

(21) Appl. No.: 10/216,472

(22) Filed: Aug. 6, 2002

(51) Int. Cl. C08K 3/26

(52) U.S. Cl. 524/425

(57) ABSTRACT

A polyformaldehyde like high polymeric compound plastic particle, includes PET, PC, plasticizer, calcium carbonate, stearic acid resin, OB fluorescent agent, and colored paint. The polyformaldehyde like high polymeric compound plastic particle may be used to make containers in an injection molding manner. Thus, the polyformaldehyde like high polymeric compound plastic particle may make various containers that cannot be made by the conventional polyformaldehyde product.

### BACKGROUND OF THE INVENTION

1. Field of the Invention

The present invention relates to a polyformaldehyde like high polymeric compound plastic particle, and more particularly to a polyformaldehyde like high polymeric compound plastic particle that may make various containers that cannot be made by the conventional polyformaldehyde product.

2. Description of the Related Art

A conventional polyformaldehyde product has stiff and heatproof features, so that it may be used to make containers that is heatproof and cannot be broken easily. However, the conventional polyformaldehyde product has the following disadvantages.

1. The conventional polyformaldehyde product is made in a press casting manner, so that the die cannot have variation during the manufacturing process. Thus, the conventional polyformaldehyde product lacks variations and diversity.

2. After the conventional polyformaldehyde product is made in a press casting manner, it is necessary to trim and grind the coarse edge by a manual work, so as to remove the coarse edge, so that the product cannot be made rapidly, thereby increasing the cost of fabrication, and thereby decreasing the productivity.

### SUMMARY OF THE INVENTION

The present invention has arisen to mitigate and/or obviate the disadvantage of the conventional polyformaldehyde product.

The primary objective of the present invention is to provide a polyformaldehyde like high polymeric compound plastic particle that may make in an injection molding manner various containers that cannot be made by the conventional polyformaldehyde product.

Another objective of the present invention is to provide a polyformaldehyde like high polymeric compound plastic particle that may be produced in an injection molding manner, so that the die may be made with various configurations during the manufacturing process, thereby increasing the styles and kinds of the product, and thereby increasing the diversity of the product. In comparison, the conventional polyformaldehyde product is made in a pressing manner, so that the conventional polyformaldehyde product lacks variations.

A further objective of the present invention is to provide a polyformaldehyde like high polymeric compound plastic particle that contains the OB fluorescent agent and the colored paint, so as to vary and enhance the color and brightness of the product.

A further objective of the present invention is to provide a polyformaldehyde like high polymeric compound plastic particle that may be directly produced in an injection molding manner, without having to trim or grind the edge of the product by a manual work, so that the product may be made rapidly, thereby reducing the cost of fabrication, and thereby increasing the productivity.

A further objective of the present invention is to provide a polyformaldehyde like high polymeric compound plastic particle that contains the primary material of PET and PC, so that the product of the present invention is heatproof and stiff, and may maintain the features of the conventional polyformaldehyde product.

A further objective of the present invention is to provide a polyformaldehyde like high polymeric compound plastic particle, wherein the bottle made of PET may thus be reused and recycled to make the product of the present invention, thereby achieving the environmental protection effect.

In accordance with the present invention, there is provided a polyformaldehyde like high polymeric compound plastic particle, comprising PET, PC, plasticizer, calcium carbonate, stearic acid resin, OB fluorescent agent, and colored paint, wherein:

a component proportion of PET is about 10% to 80% of a mixture of PET and PC;

a component proportion of PC is about 90% to 20% of the mixture of PET and PC;

an amount of the plasticizer is determined by the amount of the mixed PET and PC;

an amount of the calcium carbonate is determined by the amount of the mixed PET and PC;

an amount of the stearic acid resin is also determined by the amount of the mixed PET and PC;

an amount of the OB fluorescent agent is determined by brightness required for a polyformaldehyde like high polymeric compound plastic particle product; and

the colored paint with a determined amount may be added into the mixture of PET and PC according to the practical requirement

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a polyformaldehyde like high polymeric compound plastic particle in accordance with a preferred embodiment of the present invention.

### DETAILED DESCRIPTION OF THE INVENTION

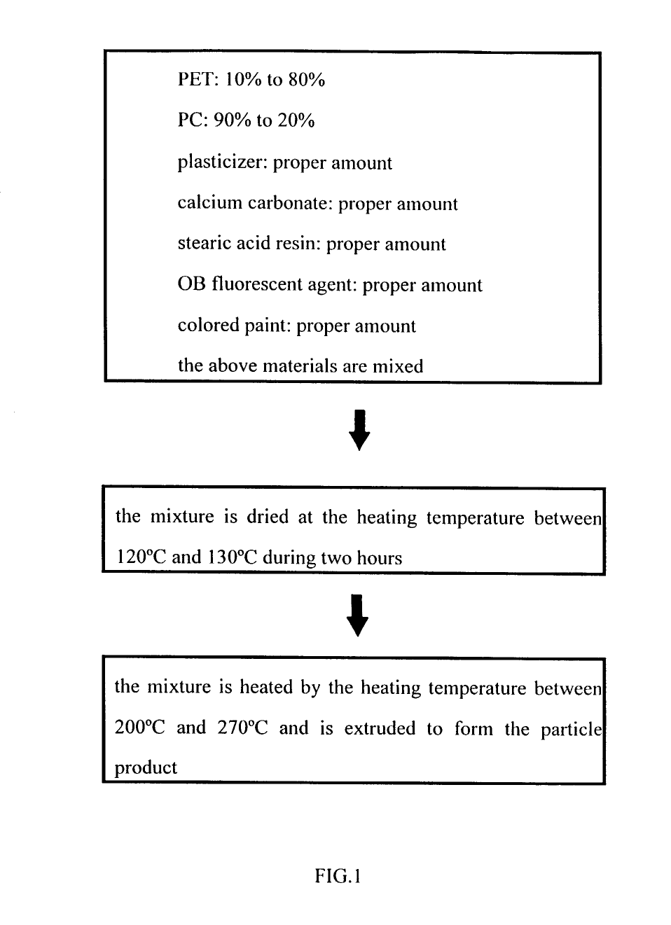

Referring to FIG. 1, a polyformaldehyde like high polymeric compound plastic particle in accordance with a preferred embodiment of the present invention comprises PET (polyethylene terephthalate), PC (polycarbonate), plasticizer, calcium carbonate, stearic acid resin, OB fluorescent agent, and colored paint.

The component proportion of PET is about 10% to 80% of the mixture of PET and PC, and the optimum component proportion of PET is about 60%. The feature of PET is in concert with PC. PET is heatproof, and is stiff. PET may decrease the component proportion of PC, thereby decreasing the cost of fabrication.

The component proportion of PC is about 90% to 20% of the mixture of PET and PC, and the optimum component proportion of PC is about 40%. PC is heatproof, and is stiff.

The plasticizer is made of DINP, DBP or the like. The amount of the plasticizer is determined by the amount of the mixed PET and PC. The plasticizer may be used to increase the extent of mixture of the mixed PET and PC, so that the mixed PET and PC may be mixed and distributed more evenly.

The amount of the calcium carbonate is determined by the amount of the mixed PET and PC. The calcium carbonate may be used to reinforce the stiffness of the product, so that the product may be used in a microwave.

The amount of the stearic acid resin is also determined by the amount of the mixed PET and PC. After PET and PC are mixed, the mixed PET and PC has erosion to the material pipe of the injection molding machine. Thus, the stearic acid resin may be added into the mixture to protect the material pipe of the injection molding machine, so that the mixed PET and PC will not wear the material pipe of the injection molding machine during the injection molding process. In addition, the stearic acid resin may be used to distribute the material, so that the mixed PET and PC may be mixed and distributed more evenly.

The amount of the OB fluorescent agent is determined by the brightness or lightness required for the product. The OB fluorescent agent may enhance the brightness of the product. The added amount of the OB fluorescent agent will affect the brightness of the product.

The colored paint with a determined amount may be added into the mixture of PET and PC according to the practical requirement, so that the product presents various colors.

When in use, the amount of PC is determined according to that of PET. When the proportion of PET is about 70%, the proportion of PC is about 30%. Both of PC and PET have the stiff and heatproof features. The cost of PET is much cheaper than that of PC. Thus, the cost may be reduced by increasing the proportion of PET. However, when the proportion of PET is too much, the product after the injection molding process is soft. Thus, the optimum proportion of PET is about 60%, and the optimum proportion of PC is about 40%.

After the above-mentioned materials of PET, PC, plasticizer, calcium carbonate, stearic acid resin, OB fluorescent agent, and colored paint are fully mixed evenly, the mixture may be dried at the heating temperature between 120° C. and 130° C. during two hours, thereby removing the moisture produced by the mixture during the stirring process. After the drying process, the mixture may be heated by the heating temperature between 200° C. and 270° C. (the optimum heating temperature is about 240° C.), and may be extruded to form the particle product. Thus, the particle product may form a polyformaldehyde like high polymeric compound plastic particle.

In such a manner, the plastic particle may be placed in the injection molding machine to produce the product in an injection molding manner, thereby forming and manufacturing the product that cannot be made by the conventional polyformaldehyde product.

Accordingly, the polyformaldehyde like high polymeric compound plastic particle in accordance with the present invention has the following advantages.

1. The product of the present invention may be produced in an injection molding manner, so that the die may be made with various configurations during the manufacturing process, thereby increasing the styles and kinds of the product, and thereby increasing the diversity of the product. In comparison, the conventional polyformaldehyde product is made in a press casting manner, so that the conventional polyformaldehyde product lacks variations.

2. The product of the present invention contains the OB fluorescent agent and the colored paint, so as to vary and enhance the color and brightness of the product.

3. The product of the present invention may be directly produced in an injection molding manner, without having to trim or grind the edge of the product by a manual work, so that the product may be made rapidly, thereby reducing the cost of fabrication, and thereby increasing the productivity.

4. The product of the present invention contains the primary material of PET and PC, so that the product of the present invention is heatproof and stiff, and may maintain the features of the conventional polyformaldehyde product.

5. The bottle made of PET may thus be reused and recycled to make the product of the present invention, thereby achieving the environmental protection effect.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A polyformaldehyde like high polymeric compound plastic particle, comprising PET, PC, plasticizer, calcium carbonate, stearic acid resin, OB fluorescent agent, and colored paint, wherein:
a component proportion of PET is about 10% to 80% of a mixture of PET and PC;
a component proportion of PC is about 90% to 20% of the mixture of PET and PC;
an amount of the plasticizer is determined by the amount of the mixed PET and PC;
an amount of the calcium carbonate is determined by the amount of the mixed PET and PC;
an amount of the stearic acid resin is also determined by the amount of the mixed PET and PC;
an amount of the OB fluorescent agent is determined by brightness required for a polyformaldehyde like high polymeric compound plastic particle product; and
the colored paint with a determined amount may be added into the mixture of PET and PC according to the practical requirement

2. The polyformaldehyde like high polymeric compound plastic particle in accordance with claim 1, wherein the optimum component proportion of PET is about 60%.

3. The polyformaldehyde like high polymeric compound plastic particle in accordance with claim 1, wherein the optimum component proportion of PC is about 40%.

4. The polyformaldehyde like high polymeric compound plastic particle in accordance with claim 1, wherein the plasticizer is made of DINP, DBP or the like.

5. The polyformaldehyde like high polymeric compound plastic particle in accordance with claim 1, wherein after the PET, PC, plasticizer, calcium carbonate, stearic acid resin, OB fluorescent agent, and colored paint are fully mixed evenly, the mixture may be dried at the heating temperature between 120° C. and 130° C. during two hours, thereby removing the moisture produced by the mixture during the stirring process.

6. The polyformaldehyde like high polymeric compound plastic particle in accordance with claim 5, wherein after the drying process, the mixture may be heated by the heating temperature between 200° C. and 270° C., and may be extruded to form the particle product.

7. The polyformaldehyde like high polymeric compound plastic particle in accordance with claim 6, wherein the optimum heating temperature is about 240° C.
